(19) United States
(12) Patent Application Publication
(10) Pub. No.: US 2022/0332309 A1
(43) Pub. Date: Oct. 20, 2022

(54) VEHICLE EXIT ASSIST APPARATUS

(71) Applicant: TOYOTA JIDOSHA KABUSHIKI KAISHA, Toyota-shi (JP)

(72) Inventors: Masaho ISHIDA, Toyota-shi (JP); Koji Takeuchi, Toyota-shi (JP); Masanori Tokuda, Miyoshi-shi (JP)

(73) Assignee: TOYOTA JIDOSHA KABUSHIKI KAISHA, Toyota-shi (JP)

(21) Appl. No.: 17/703,290

(22) Filed: Mar. 24, 2022

(30) Foreign Application Priority Data
Apr. 12, 2021 (JP) 2021-067293

(51) Int. Cl. B60W 30/08; B60W 40/08; B60W 40/04

(52) U.S. Cl. CPC B60W 30/08; B60W 40/08; B60W 40/04; B60W 2554/4049; B60W 2554/4041

(57) ABSTRACT

A vehicle exit assist apparatus includes a target information acquisition device configured to detect a target present around a vehicle and acquire information regarding the detected target as target information; and a control unit configured to determine whether or not an obstruction target having a possibility of obstructing a safe vehicle exit of an occupant of the vehicle while the vehicle is stopped is present based on the target information, and to execute vehicle exit assist control that assists in the safe vehicle exit of the occupant when determination is made that the obstruction target is present. The control unit is configured to determine whether or not the obstruction target is a human being, and not to execute the vehicle exit assist control when determination is made that the obstruction target is a human being.

### CROSS-REFERENCE TO RELATED APPLICATION

This application claims priority to Japanese Patent Application No. 2021-067293 filed on Apr. 12, 2021, incorporated herein by reference in its entirety.

### BACKGROUND

### 1. Technical Field

The present disclosure relates to a vehicle exit assist apparatus capable of executing vehicle exit assist control.

### 2. Description of Related Art

Conventionally, there has been known a vehicle exit assist apparatus that executes vehicle exit assist control which is control of giving an occupant an alarm or restricting the degree of door opening when an obstruction target having a possibility of obstructing a safe vehicle exit of the occupant of a vehicle while the vehicle is stopped is detected (see, for example, Japanese Unexamined Patent Application Publication No. 2018-8576 (JP 2018-8576 A)).

### SUMMARY

With the execution of the vehicle exit assist control, it is possible to reduce the possibility that the door or the occupant comes into contact with the obstruction target. On the other hand, when the vehicle exit assist control is executed in spite of a situation in which the control is unnecessary, the occupant may be annoyed or the safe vehicle exit of the occupant may be hindered. Here, the “situation in which the vehicle exit assist control is unnecessary” is, for example, a situation in which a target that does not actually correspond to the obstruction target is erroneously detected as the obstruction target. For this reason, there has been a demand to restrain the unnecessary operation of the vehicle exit assist control and improve the reliability of the control.

The present disclosure has been made to address the above-described problem. That is, the present disclosure is to provide a vehicle exit assist apparatus capable of restraining the unnecessary operation of vehicle exit assist control.

A first aspect of the present disclosure relates to a vehicle exit assist apparatus (hereinafter, referred to as “the present disclosure apparatus”) including a target information acquisition device (12) and a control unit (10; 110).
The target information acquisition device (12) is configured to detect a target present around a vehicle and acquire information regarding the detected target as target information.
The control unit (10; 110) is configured to determine whether or not an obstruction target having a possibility of obstructing a safe vehicle exit of an occupant of the vehicle while the vehicle is stopped is present based on the target information, and to execute vehicle exit assist control that assists in the safe vehicle exit of the occupant when determination is made that the obstruction target is present.
The control unit (10; 110) is configured
to determine whether or not the obstruction target is a human being (step S330), and
not to execute the vehicle exit assist control when determination is made that the obstruction target is a human being (step S330: Yes).

In general, when a target other than a human being (for example, vehicles and bicycles) changes the course due to some factor (for example, lane change or avoidance of obstacles) while the target is moving, the target then tends to move along the changed course. On the contrary, a human being tends to move back to the course that the human being has been supposed to pass before the change of the course depending on the situation, even when the human being changes the course due to some factor while the human being is moving. For example, when the human being changes the course in an attempt to pass each other in order to avoid a collision with an oncoming target, the human being tends to move back to the course that the human being has been supposed to pass before the change of the course, after the passing with each other. For this reason, when the target is a human being, the human being may be erroneously determined to be the obstruction target due to a temporary change of course even though the human being does not actually correspond to the obstruction target. In this case, the vehicle exit assist control is unnecessarily operated, which is not preferable.

In addition, the moving speed of the human being is generally relatively low. Therefore, when a door is opened by the occupant of the vehicle while the vehicle is stopped, the human being can relatively easily avoid contact with the door or the occupant by stopping or changing the course. That is, the possibility that the human being obstructs a safe vehicle exit of the occupant is relatively low, in the first place. Further, even if the human being comes into contact with the door or the occupant, the magnitude of the impact is much smaller than the magnitude of the impact when the target other than a human being comes into contact with the door or the occupant.

In that regard, the present disclosure apparatus is configured to determine whether or not the obstruction target is a human being and not to execute the vehicle exit assist control when determination is made that the obstruction target is a human being. With the configuration, the unnecessary operation of the vehicle exit assist control can be restrained, and the reliability of the control can be improved. In other words, the present disclosure apparatus prioritizes restraining the unnecessary operation of the vehicle exit assist control rather than executing the control to a target (that is, a human being) having a relatively low possibility of obstructing a safe vehicle exit of the occupant.

In the vehicle exit assist apparatus according to the first aspect,
the vehicle exit assist control may include a normal vehicle exit assist control and a low-level vehicle exit assist control of which a level of assist is lower than a level of assist of the normal vehicle exit assist control.
The control unit (10) may be configured
to determine whether or not each of a plurality of doors provided in the vehicle is in an open state (step S340), when determination is made that the obstruction target is not a human being (step S330: No),
to execute the normal vehicle exit assist control (step S350) when determination is made that the door on a side where the obstruction target is determined to be present is in an open state (step S340: Yes), and
to execute the low-level vehicle exit assist control (step S360) when determination is made that the door on the side where the obstruction target is determined to be present is in a closed state (step S340: No).

When the door on the side where the obstruction target is determined to be present is in an open state, it is considered that there is a high possibility that the occupant is going to exit from the door. Therefore, it is possible to appropriately notify the occupant of the presence of the obstruction target by executing the normal vehicle exit assist control when the door is in an open state, and as a result, the possibility that the occupant can exit from the vehicle safely becomes high. On the other hand, when the door on the side where the obstruction target is detected is in a closed state, whether or not the occupant is going to exit from the door cannot be distinguished. In other words, both the possibility that the occupant has intention to exit but has not opened the door at this time, and the possibility that the occupant has no intention to exit and the door remains closed are conceivable. Therefore, the low-level vehicle exit assist control is executed when the door is in a closed state, so that it is possible to achieve both “notifying the occupant who has intention to exit of the presence of the obstruction target in advance” and “giving no annoyance caused by the execution of the normal vehicle exit assist control to the occupant who has no intention to exit”.

The vehicle exit assist apparatus according to the first aspect may further include an imaging device (114).
The imaging device (114) may be configured to image the occupant in the vehicle and acquire information regarding the imaged occupant as imaging information.
The control unit (110) may be configured
to determine whether or not the occupant has intention to exit based on the imaging information (step S640), when determination is made that the obstruction target is not a human being (step S330: No),
to execute the vehicle exit assist control (step S650) when determination is made that the occupant has intention to exit from a door on a side where the obstruction target is determined to be present (step S640: Yes), and
not to execute the vehicle exit assist control when determination is made that the occupant has no intention to exit from the door on the side where the obstruction target is determined to be present (step S640: No).

In the first aspect of the present disclosure, determination is made whether or not the occupant has intention to exit based on the imaging information. With the imaging information used, it is possible to accurately determine whether or not the occupant has intention to exit. Therefore, the vehicle exit assist control is executed solely when determination is made that the occupant has intention to exit based on the imaging information, so that the reliability of the vehicle exit assist control can be improved.

In the vehicle exit assist apparatus according to the first aspect,
The control unit (110) may be configured
to determine whether or not each of a plurality of doors provided in the vehicle is in an open state, when determination is made that the obstruction target is not a human being,
to execute the vehicle exit assist control when determination is made that the door on a side where the obstruction target is determined to be present is in an open state, and
not to execute the vehicle exit assist control when determination is made that the door on the side where the obstruction target is determined to be present is in a closed state.

In the first aspect of the present disclosure, determination is made whether or not the occupant has intention to exit based on the open/closed state of the door. When determination is made that the door is in a closed state, it is considered that the occupant has not exited because the door has not been opened at least at this time. Therefore, the vehicle exit assist control is executed solely when determination is made that the occupant has intention to exit based on the open/closed state of the door, so that the reliability of the vehicle exit assist control can be improved.

In the above description, in order to help the understanding of the present disclosure, signs used in the embodiments are attached in parentheses to the constituent elements of the present disclosure corresponding to the embodiment, but each constituent element of the present disclosure is not limited to the embodiment defined by the sign.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a vehicle exit assist apparatus (first embodiment apparatus) according to a first embodiment of the present disclosure;

FIG. 2 is a view showing a solid object detection range of a radar sensor provided in the first embodiment apparatus, and showing a situation in which a pedestrian A and a pedestrian B are going to pass each other in order to avoid a collision;

FIG. 3 is a flowchart showing a routine executed by a CPU of a vehicle exit assist ECU of the first embodiment apparatus;

FIG. 4 is a view showing a solid object detection range of a radar sensor provided in a vehicle exit assist apparatus according to a modification example of the first embodiment;

FIG. 5 is a schematic configuration diagram of a vehicle exit assist apparatus (second embodiment apparatus) according to a second embodiment of the present disclosure; and

FIG. 6 is a flowchart showing a routine executed by a CPU of a vehicle exit assist ECU of the second embodiment apparatus.

### DETAILED DESCRIPTION OF EMBODIMENTS

### First Embodiment

### Configuration

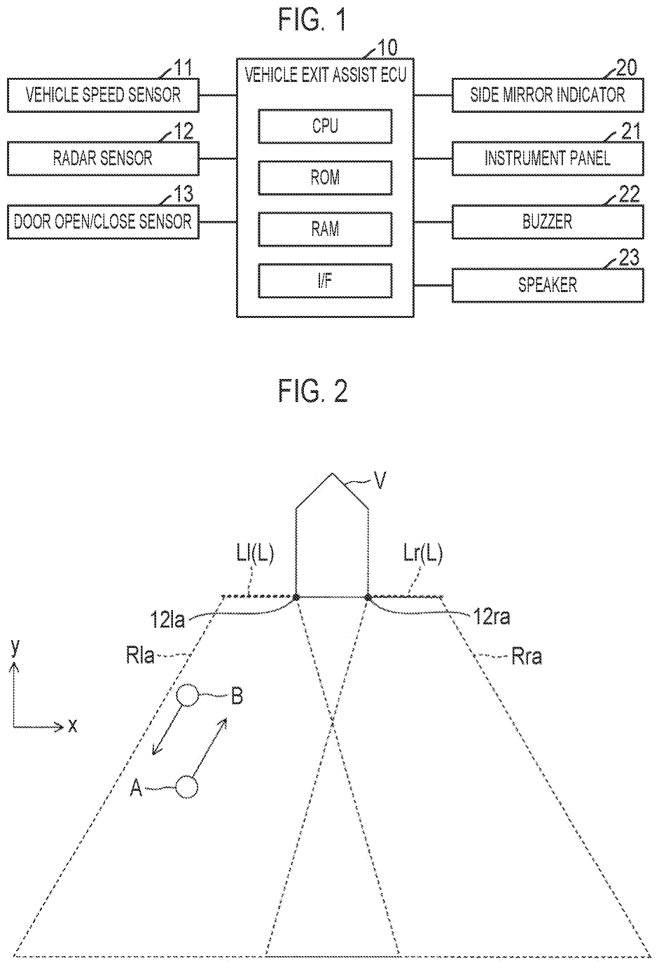

Hereinafter, a vehicle exit assist apparatus (hereinafter, also referred to as a “first embodiment apparatus”) according to a first embodiment of the present disclosure will be described with reference to the drawings. As shown in FIG. 1, the first embodiment apparatus includes a vehicle exit assist ECU 10, and a vehicle speed sensor 11, a radar sensor 12, a door open/close sensor 13, a side mirror indicator 20, an instrument panel 21, a buzzer 22, and a speaker 23 connected to the vehicle exit assist ECU 10. The vehicle exit assist ECU 10 includes a microcomputer as a main part. The ECU is an abbreviation for an electronic control unit. The microcomputer includes a CPU, a ROM, a RAM, an interface (I/F), and the like, and the CPU executes instructions (programs, routines) stored on the ROM to realize various functions. Hereinafter, a vehicle on which the first embodiment apparatus is mounted is referred to as a “host vehicle”.

The vehicle exit assist ECU 10 is configured to acquire signals generated or output by the sensors 11 to 13 every time a predetermined time elapses, and to control the elements (devices) 20 to 23 based on the acquired signals. Hereinafter, the vehicle exit assist ECU 10 is also simply referred to as an “ECU 10”.

The vehicle speed sensor 11 generates a signal corresponding to the traveling speed of the host vehicle (hereinafter, referred to as a “vehicle speed”). The ECU 10 acquires the signal generated by the vehicle speed sensor 11 and calculates the vehicle speed based on the signal. When the vehicle speed is zero, the ECU 10 determines that the host vehicle is in a stopped state (hereinafter, also referred to as “while the host vehicle is stopped”).

The radar sensor 12 (target information acquisition device) has a function of acquiring information regarding a solid object (target) present around the host vehicle. The solid object includes a moving object (a pedestrian, a bicycle, a vehicle, and the like) and a fixed object (a guardrail, a side wall, a median strip, a roadside tree, and the like). Note that, the moving object means a movable object, and does not mean solely an object that is moving.

As shown in FIG. 2, the radar sensor 12 includes a left radar sensor 12la provided at the left rear corner of a host vehicle V and a right radar sensor 12ra provided at the right rear corner of the host vehicle V. The radar sensor 12 irradiates the periphery of the host vehicle with a millimeter radio wave. Specifically, the left radar sensor 12la irradiates a range including a left-side region Rla behind and to the side of the host vehicle with a radio wave, and the right radar sensor 12ra irradiates a range including a right-side region Rra behind and to the side of the host vehicle with a radio wave. Both the left-side region Rla and the right-side region Rra have a shape that becomes longer outward in the vehicle width direction and inward in the vehicle width direction as the left-side region Rla and the right-side region Rra are farther rearward from the host vehicle V. Note that, in FIG. 2, for convenience of illustration, the ratios of the regions Rla and Rra to the host vehicle V and the like are changed and shown.

When the solid object is present within the irradiation range of the radio wave, the radar sensor 12 receives the reflected wave from the solid object. The radar sensor 12 calculates the presence or absence of the solid object and the relative relationship between the host vehicle and the solid object (the distance from the host vehicle to the solid object, the direction of the solid object with respect to the host vehicle, and the speed of the solid object relative to the host vehicle, and the like), based on the irradiation timing, the reception timing of the radio wave, and the like. In other words, the radar sensor 12 detects a solid object present around the host vehicle. In addition, when a solid object is present, the radar sensor 12 acquires the reflection intensity of the radio wave from the solid object. The radar sensor 12 outputs the information regarding the solid object present in the regions Rla and Rra to the ECU 10 as target information.

The radar sensor 12 may irradiate not solely a region behind and to the sides of the host vehicle but also a region behind the host vehicle with a radio wave. In addition, as the radar sensor 12, a sensor that is used for blind-spot monitor control may be used. The blind-spot monitor control is control in which a driver of the host vehicle is alerted when a vehicle approaching the host vehicle from behind the host vehicle (in particular, a vehicle present in a region where it is difficult for the driver to check with a side mirror) is detected.

Further, the first embodiment apparatus may include a camera sensor (not shown) connected to the ECU 10. The camera sensor photographs the landscapes of the regions Rla and Rra, calculates information indicating the presence or absence of a solid object, a relative relationship between the host vehicle and the solid object, and whether or not the solid object is a human being, based on the photographed image data, and outputs the information to the ECU 10 as target information. The ECU 10 may detect a rear approaching target, which will be described later, by combining the target information obtained by the radar sensor 12 and the target information obtained by the camera sensor.

Returning to FIG. 1, description will be continued. The door open/close sensor 13 is provided for each of a plurality of doors (more specifically, side doors) provided in the host vehicle. The door open/close sensor 13 detects the open/closed state of the door. When the door open/close sensor 13 detects that the door is in an open state, the door open/close sensor 13 generates an open signal indicating that the door is in the open state during the period in which the open state is detected. When the door open/close sensor 13 detects that the door is in a closed state, the door open/close sensor 13 generates a close signal indicating that the door is in the closed state during the period in which the closed state is detected. The ECU 10 detects whether each of the door open/close sensors 13 generates the open signal or the close signal, and detects whether the door corresponding to the door open/close sensor 13 is in the open state or the closed state based on the detection result.

The side mirror indicator 20 is provided at a predetermined position of each of right and left side mirrors of the host vehicle, and the side mirror indicators 20 can be turned on and off independently of each other. The instrument panel 21 is provided in front of the driver's seat of the host vehicle (position visible to the driver). The buzzer 22 is built in the instrument panel 21. The speaker 23 is a component of a navigation system (not shown) and is provided in the vicinity of a touch panel display (not shown).

### Details of Operation

The first embodiment apparatus is configured to execute the vehicle exit assist control that assists in the safe vehicle exit of the occupant while the host vehicle is stopped. In the present embodiment, alarm control (described later) is executed as the vehicle exit assist control. Hereinafter, description will be made in detail.

The ECU 10 executes alarm control when all of following conditions 1 to 3 are satisfied.
(Condition 1) The host vehicle is in a stopped state.
(Condition 2) A rear approaching target (described later) is detected.
(Condition 3) The detected rear approaching target is a moving object other than a human being (described later).

First, condition 1 will be described. Whether or not condition 1 is satisfied may be determined based on the vehicle speed acquired from the vehicle speed sensor 11.

Next, condition 2 will be described. The rear approaching target means a moving object that approaches the host vehicle from behind the host vehicle and that has a possibility of obstructing the safe vehicle exit of the occupant. The ECU 10 detects the rear approaching target as follows. That is, when the ECU 10 determines that a solid object is present in the left-side region Rla or the right-side region Rra based on the target information acquired from the radar sensor 12, the ECU 10 calculates the time to collision (TTC) that is the estimated time needed for collision with or closest approach to the host vehicle of the solid object. The TTC may be defined as the time for the solid object to intersect the virtual line L (in other words, the time for the solid object to reach the intersection point of the velocity vector of the solid object and the virtual line L), and may be calculated based on the target information. More specifically, as shown in FIG. 2, the virtual line L includes a left-side virtual line L1 and a right-side virtual line Lr (see broken line). The left-side virtual line L1 passes through the left rear corner of the host vehicle V and extends outward (leftward) in the vehicle width direction, and the length thereof is substantially the same as the length of the left-side region Rla in the vehicle width direction, in the left rear corner. The right-side virtual line Lr passes through the right rear corner of the host vehicle V and extends outward (rightward) in the vehicle width direction, and the length thereof is substantially the same as the length of the right-side region Rra in the vehicle width direction, in the right rear corner. When the velocity vector of a certain solid object does not intersect the virtual line L, the TTC cannot be calculated. Therefore, the solid object is not detected as the rear approaching target (the solid object does not correspond to the rear approaching target). The rear approaching target corresponds to an example of the “obstruction target”.

In a case where the TTC when the solid object intersects the left-side virtual line Ll is a predetermined time threshold value TTCth or less, the ECU 10 determines that the solid object has a possibility of obstructing the safe vehicle exit from the left-side door of the occupant and detects the solid object as the rear approaching target with respect to the left-side door. On the other hand, in a case where the TTC when the solid object intersects the right-side virtual line Lr is the time threshold value TTCth or less, the ECU 10 determines that the solid object has a possibility of obstructing the safe vehicle exit from the right-side door of the occupant and detects the solid object as the rear approaching target with respect to the right-side door.

Subsequently, condition 3 will be described. The ECU 10 determines whether or not the detected rear approaching target is a human being based on the target information. Specifically, the ECU 10 determines that the rear approaching target is a human being when both the speed condition and the reflection intensity condition, which will be described later, are satisfied, and determines that the rear approaching target is a moving object other than a human being when at least one of the conditions is not satisfied. The speed condition is a condition that is satisfied when the speed of the rear approaching target included in the target information is a predetermined speed threshold value or less. The reflection intensity condition is a condition that is satisfied when the reflection intensity of the rear approaching target included in the target information is a predetermined intensity threshold value or less and fluctuation is detected in the transition of the reflection intensity over time. According to the determination method, a bicycle (strictly speaking, a bicycle and a human being who moves with the bicycle) is not determined to be a human being. Note that, the method of determining whether or not the rear approaching target is a human being is not limited to this. For example, the ECU 10 may be configured to determine that the rear approaching target is a human being when either the speed condition or the reflection intensity condition is satisfied.

Further, whether or not the reflection intensity condition is satisfied may be determined by the radar sensor 12 instead of the ECU 10.

Next, the alarm control will be described. The alarm control includes normal alarm control and low-level alarm control. The ECU 10 performs following processing 1 to processing 4 as the normal alarm control, and performs solely processing 1 as the low-level alarm control. That is, the low-level alarm control provides a lower level of alarm than the normal alarm control (in other words, the level of assist of the low-level alarm control is lower than the level of assist of the normal alarm control).
(Processing 1) The side mirror indicator 20 on the side where the rear approaching target is detected is turned on.
(Processing 2) A predetermined mark (for example, a mark that clearly indicates whether the rear approaching target is approaching from the right-rear or left-rear direction) is displayed on the instrument panel 21.
(Processing 3) The buzzer 22 is sounded.
(Processing 4) The speaker 23 is made to utter a predetermined message (for example, a message “Be careful of approaching vehicles”).

The ECU 10 executes the normal alarm control as alarm control when the door on the side where the rear approaching target is detected is in the open state in a case where all conditions 1 to 3 are satisfied. On the other hand, the ECU 10 executes the low-level alarm control as the alarm control when the door on the side where the rear approaching target is detected is in the closed state in a case where all conditions 1 to 3 are satisfied. The normal alarm control corresponds to an example of the “normal vehicle exit assist control”, and the low-level alarm control corresponds to an example of the “low-level vehicle exit assist control”. Note that, the processing performed as the low-level alarm control is not limited to processing 1. The content of the low-level alarm control does not matter as long as the processing is less likely to give annoyance (for example, sound) directly to the occupant (for example, processing 2 may be performed).

When the door on the side where the rear approaching target is detected is in the open state, it is considered that there is a high possibility that the occupant is going to exit from the door. Therefore, it is possible to appropriately notify the occupant of the presence of the rear approaching target by executing the normal alarm control when the door is in the open state, and as a result, the possibility that the occupant can exit from the vehicle safely becomes high. On the other hand, when the door on the side where the rear approaching target is detected is in the closed state, whether or not the occupant is going to exit from the door cannot be distinguished. In other words, both the possibility that the occupant has intention to exit but has not opened the door at this time, and the possibility that the occupant has no intention to exit and the door remains closed are conceivable. Therefore, the low-level alarm control is executed when the door is in the closed state, so that it is possible to achieve both “notifying the occupant who has intention to exit of the presence of the rear approaching target” and “giving no annoyance caused by the execution of the normal alarm control to the occupant who has no intention to exit”.

In contrast, the ECU 10 does not execute the alarm control when at least one of conditions 1 to 3 is not satisfied. The case where condition 1 is not satisfied is a case where the host vehicle is in a traveling state. In this case, the alarm control is not executed because it is clear that the occupant does not exit. The case where condition 2 is not satisfied is a case where the rear approaching target is not detected. In this case, the alarm control is not executed because the target of the alarm control is not present. The case where condition 3 is not satisfied is a case where the rear approaching target is a human being. The reason why the alarm control is not executed in this case will be described in detail with reference to FIG. 2.

FIG. 2 is a view illustrating a situation in which a pedestrian A who walks in a y-axis direction and a pedestrian B who walks in a −y-axis direction are going to pass each other in order to avoid a collision. Both the pedestrians A and B change their courses to the right with respect to the traveling direction in order to pass each other (see the arrow). Generally, in a case where pedestrians pass each other, the pedestrians change their courses once to avoid each other, and then return the courses in the original traveling direction while returning back to the position before the passing with each other in an x-axis direction. Therefore, it is considered that the pedestrian A returns the course in the y-axis direction while returning back to the position before the passing with each other in the x-axis direction, after the pedestrian A has passed the pedestrian B. The ±x-axis direction corresponds to the vehicle width direction or the right-left direction, and the ±y-axis direction corresponds to the front-rear direction of the host vehicle V. Further, the behavior of the pedestrian caused by the passing with each other is not limited to the case where the other party is a pedestrian, and is also the same in the case of other solid objects.

Here, as is clear from the positional relationship between the pedestrian A and the virtual line L (particularly, the left-side virtual line Ll) shown in FIG. 2, the pedestrian A is not detected as the rear approaching target as long as the pedestrian A is walking in the y-axis direction, even if the pedestrian A is detected in the left-side region Rla. This is because the velocity vector of the pedestrian A does not intersect the virtual line L. However, when the pedestrian A temporarily changes the course in order to pass the pedestrian B and the velocity vector thereof intersects the virtual line L (in this example, the left-side virtual line Ll), the pedestrian A is a calculation target for the TTC. When the TTC is TTCth or less, the pedestrian A is detected as the rear approaching target and the alarm control is executed. The alarm control is continued until the pedestrian A begins to return the course in the original traveling direction and the velocity vector thereof no longer intersects the virtual line L. Since the pedestrian B is walking in a direction away from the virtual line L, the pedestrian B is not a calculation target for the TTC even if the pedestrian B is detected in the left-side region Rla.

That is, according to the above example, even a moving object, such as the pedestrian A, that does not actually correspond to the rear approaching target may be erroneously detected as the rear approaching target due to a temporary change in course caused by the passing with each other or the like, and unnecessary alarm control may be operated. The unnecessary alarm control is not preferable because the unnecessary alarm control may bother or annoy the occupant.

In addition, generally, the moving speed of a human being is relatively low. Therefore, when the door is opened by the occupant of the vehicle while the vehicle is stopped, the human being can relatively easily avoid contact with the door or the occupant by stopping or changing the course. That is, the possibility that the human being obstructs the safe vehicle exit of the occupant is relatively low, in the first place. Further, even if the human being comes into contact with the door or the occupant, the magnitude of the impact is much smaller than the magnitude of the impact when the moving object (typically, a vehicle) other than a human being comes into contact with the door or the occupant.

In that regard, the ECU 10 is configured not to execute the alarm control when the rear approaching target is a human being (when condition 3 is not satisfied). With the configuration, the frequency with which unnecessary alarm control is executed can be significantly reduced, and the reliability of the alarm control can be improved.

### Specific Operation

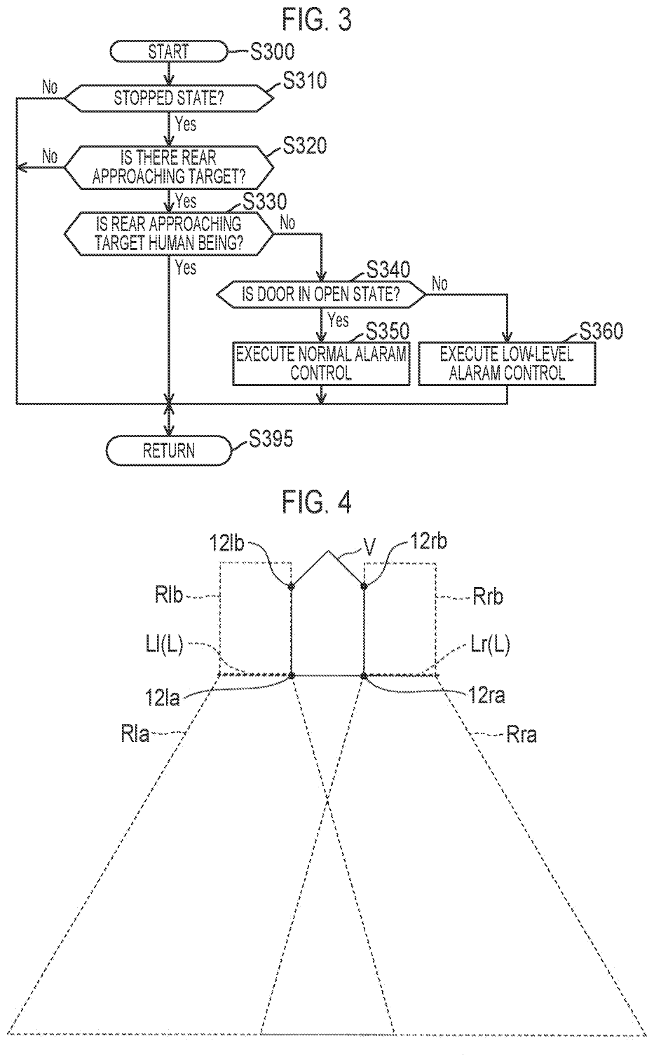

Subsequently, the specific operation of the ECU 10 will be described. The CPU of the ECU 10 is configured to repeatedly execute the routine shown by the flowchart in FIG. 3 every time a predetermined time elapses during the period in which the power is supplied to the ECU 10 (described later).

At a predetermined timing, the CPU starts processing from step S300 in FIG. 3, proceeds to step S310, and determines whether or not the host vehicle is in the stopped state based on the vehicle speed acquired from the vehicle speed sensor 11 (condition 1). When the host vehicle is in the traveling state, the CPU determines “No” in step S310 (that is, determines that condition 1 is not satisfied), and proceeds to step S395 to tentatively terminate the present routine. That is, the alarm control is not executed. On the other hand, when the host vehicle is in the stopped state, the CPU determines “Yes” in step S310 (that is, determines that condition 1 is satisfied), and proceeds to step S320.

In step S320, the CPU determines whether or not a rear approaching target is detected based on the target information acquired from the radar sensor 12 (condition 2). When the rear approaching target is not detected, the CPU determines “No” in step S320 (that is, determines that condition 2 is not satisfied), and proceeds to step S395 to tentatively terminate the present routine. That is, the alarm control is not executed. On the other hand, when the rear approaching target is detected, the CPU determines “Yes” in step S320 (that is, determines that condition 2 is satisfied), and proceeds to step S330.

In step S330, the CPU determines whether or not the detected rear approaching target is a human being based on the target information (condition 3). When the rear approaching target is a moving object other than a human being, the CPU determines “No” in step S330 (that is, determines that condition 3 is satisfied), and proceeds to step S340.

In step S340, the CPU determines whether or not the door on the side where the rear approaching target is detected is in the open state based on the signal acquired from the door open/close sensor 13. When the door is in the open state, the CPU determines “Yes” in step S340, and executes the normal alarm control (processing 1 to processing 4) in step S350. After that, the CPU proceeds to step S395 to tentatively terminate the present routine. On the other hand, when the door is in the closed state, the CPU determines “No” in step S340 and executes the low-level alarm control (processing 1) in step S360. After that, the CPU proceeds to step S395 to tentatively terminate the present routine.

On the other hand, when the rear approaching target is a human being, the CPU determines “Yes” in step S330 (that is, determines that condition 3 is not satisfied), and proceeds to step S395 to tentatively terminate the present routine. That is, the alarm control is not executed.

The power supply to the ECU 10 is continued even after an ignition switch is turned off until a predetermined condition is satisfied. For example, the condition may be satisfied at the time when the door is locked, or may be satisfied at the time when a predetermined stop time has elapsed after the host vehicle has stopped. With the configuration, it is possible to reduce the possibility that the vehicle exit assist control is not executed in a situation in which the control is needed, and the vehicle exit assist control can be executed more appropriately.

As described above, with the first embodiment apparatus, the unnecessary operation of the alarm control can be restrained, and the reliability of the control can be improved. In other words, the first embodiment apparatus prioritizes restraining the unnecessary operation of the alarm control rather than executing the control to the rear approaching target (that is, a human being) having a relatively low possibility of obstructing the safe vehicle exit of the occupant.

Whether or not to execute the low-level alarm control may be switchable (customizable) by the occupant (typically, the driver). This may be achieved, for example, by selecting whether or not the occupant wants the execution of the low-level alarm control on the touch panel display (a component of the navigation system).

### Modification Example

Next, a vehicle exit assist apparatus (hereinafter, also referred to as a “first modification apparatus”) according to a modification example of the first embodiment will be described with reference to FIG. 4. Hereinafter, the differences from the first embodiment apparatus will be mainly described (the same applies to a second embodiment and a modification example thereof). The first modification apparatus is different from the first embodiment apparatus in that the first modification apparatus is configured to detect not solely the rear approaching target but also a side target, as the obstruction target.

Specifically, as shown in FIG. 4, the first modification apparatus further includes a right radar sensor 12rb and a left radar sensor 121b in addition to the right and left radar sensors 12ra and 121a, as the radar sensor 12. The left radar sensor 121b is provided below a headlamp (not shown) on the left side of the host vehicle V, and the right radar sensor 12rb is provided below a headlamp (not shown) on the right side of the host vehicle V. Since the configurations of the right and left radar sensors 12rb and 121b are substantially the same as the configurations of the right and left radar sensors 12ra and 121a, detailed description thereof will be omitted. The left radar sensor 121b irradiates a range including a left-side region Rlb on the side of the host vehicle with a radio wave, and the right radar sensor 12rb irradiates a range including a right-side region Rrb on the side of the host vehicle with a radio wave. Both the left-side region Rlb and the right-side region Rrb have a substantially rectangular shape. In FIG. 4, for convenience of illustration, the ratios of the regions Rlb and Rrb to the host vehicle V and the like are changed and shown.

The radar sensor 12 outputs information regarding a solid object present in the regions Rla, Rra, Rlb, and Rrb to the ECU 10 as the target information. In the present modification example, the ECU 10 determines whether or not each of following conditions 2-2 and 3-2 is satisfied instead of conditions 2 and 3 when the ECU 10 determines whether or not to execute the alarm control.
(Condition 2-2) A rear approaching target or a side target (described later) is detected.
(Condition 3-2) The detected rear approaching target or side target is a solid object other than a human being (described later).

First, the side target of condition 2-2 will be described. The side target means a solid object that has a possibility of obstructing the safe vehicle exit of the occupant by being present on the side of the host vehicle. The ECU 10 detects the side target as follows. That is, when the ECU 10 determines that a solid object is present in the left-side region Rlb based on the target information acquired from the radar sensor 12, the ECU 10 determines that the solid object has a possibility of obstructing the safe vehicle exit of the occupant by being present on the left side of the host vehicle, and detects the solid object as the side target. Similarly, when the ECU 10 determines that a solid object is present in the right-side region Rrb, the ECU 10 determines that the solid object has a possibility of obstructing the safe vehicle exit of the occupant by being present on the right side of the host vehicle, and detects the solid object as the side target. As is clear from the above description, the ECU 10 does not calculate the TTC for the solid object detected in the region Rlb or Rrb, and immediately determines that the solid object is “a solid object having a possibility of obstructing the safe vehicle exit of the occupant”. The rear approaching target and the side target correspond to an example of the “obstruction target”.

Next, the side target of condition 3-2 will be described. The ECU 10 determines whether or not the detected side target is a human being by the same procedure based on the target information. That is, the ECU 10 determines that the side target is a human being when both the speed condition and the reflection intensity condition are satisfied, and determines that the side target is a solid object other than a human being when at least one of the conditions is not satisfied.

The ECU 10 executes following processing 1-2, processing 2-2, and processing 4-2 instead of processing 1, processing 2, and processing 4 when the ECU 10 executes the alarm control.
(Processing 1-2) The side mirror indicator 20 on the side where the rear approaching target and/or the side target is detected is turned on.
(Processing 2-2) A predetermined mark (for example, a mark that clearly indicates whether the rear approaching target is approaching from the right-rear or left-rear direction, and/or a mark that clearly indicates whether the side target is present on the right side or left side) is displayed on the instrument panel 21.
(Processing 4-2) The speaker 23 is made to utter a predetermined message (for example, a message “Be careful of approaching vehicles” and/or “Be careful of the surroundings”).

Even with the configuration, the same operation and effect as those of the first embodiment apparatus can be obtained. In addition, not solely the rear approaching target but also the side target is targeted for the alarm control, so that the reliability of the vehicle exit assist control is improved.

The configuration of the present modification example may be applied not solely to the first embodiment but also to the second embodiment and the modification example thereof.

### Second Embodiment

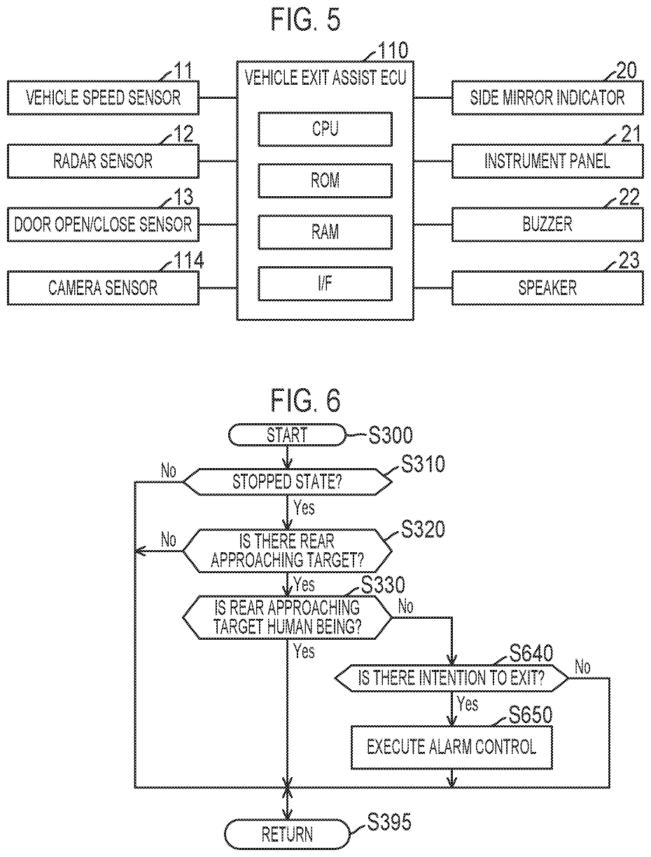

Subsequently, a vehicle exit assist apparatus (hereinafter, also referred to as a “second embodiment apparatus”) according to the second embodiment of the present disclosure will be described with reference to FIGS. 5 and 6. The second embodiment apparatus is different from the first embodiment apparatus in the following points.
A camera sensor capable of imaging the occupant of the host vehicle is further provided.
Whether or not the occupant has intention to exit is determined.
Solely the normal alarm control is executed as the alarm control.
Hereinafter, a description will be made in detail.

As shown in FIG. 5, the second embodiment apparatus includes a vehicle exit assist ECU 110 (hereinafter, also simply referred to as an “ECU 110”). The ECU 110 is different from the ECU 10 in that the ECU 110 includes a camera sensor 114. The camera sensor 114 is installed in the vehicle and is configured to image all occupants. The camera sensor 114 outputs information regarding the imaged occupant to the ECU 110 as the imaging information every time a predetermined time elapses.

When all conditions 1 to 3 are satisfied, the ECU 110 determines whether or not each of the occupants has intention to exit from the door on the side where the rear approaching target is detected, based on the imaging information. In the present embodiment, the ECU 110 determines that the occupant has intention to exit when it is presumed that the occupant is performing an act of trying to open the door, and determines that the occupant has no intention to exit when it is presumed that the occupant is not performing such an act. The “act of trying to open the door” is, for example, an act of the occupant operating a door operation portion (typically, an inner lever or a switch) in order to open the door.

The ECU 110 executes the normal alarm control as the alarm control when determination is made that a certain occupant has intention to exit from the door on the side where the rear approaching target is detected. On the other hand, the ECU 110 does not execute the alarm control when determination is made that all the occupants have no intention to exit from the door on the side where the rear approaching target is detected. That is, in the second embodiment, the alarm control does not include the low-level alarm control, and the alarm control is executed solely when the occupant has intention to exit.

### Specific Operation

Subsequently, the specific operation of the ECU 110 will be described. The CPU of the ECU 110 is configured to repeatedly execute the routine shown by the flowchart in FIG. 6 every time a predetermined time elapses during the period in which the power is supplied to the ECU 10. The flowchart of FIG. 6 is different from the flowchart of FIG. 3 in that steps S640 and S650 are executed instead of steps S340 to S360 (see FIG. 3). Therefore, the differences will be mainly described below.

The CPU starts processing from step S300 in FIG. 6. When the host vehicle is in a stopped state, the rear approaching target is detected, and the rear approaching target is a moving object other than a human being, the CPU determines “Yes” in step S310, determines “Yes” in step S320, and determines “No” in step S330 (that is, determines that all conditions 1 to 3 are satisfied), and proceeds to step S640.

In step S640, the CPU determines whether or not the occupant has intention to exit from the door on the side where the rear approaching target is detected. When the occupant has intention to exit from the door, the CPU determines “Yes” in step S640 and executes the alarm control (processing 1 to processing 4) in step S650. After that, the CPU proceeds to step S395 to tentatively terminate the present routine. On the other hand, when the occupant has no intention to exit from the door, the CPU determines “No” in step S640 and proceeds to step S395 to tentatively terminate the present routine. That is, in a case where the occupant has no intention to exit from the door on the side where the rear approaching target is detected even when the rear approaching target detected while the vehicle is stopped is a moving object other than a human being, the CPU does not execute the alarm control.

As described above, the second embodiment apparatus determines whether or not the occupant has intention to exit based on the imaging information. With the imaging information used, it is possible to accurately determine whether or not the occupant has intention to exit. Therefore, the alarm control is executed solely when determination is made that the occupant has intention to exit based on the imaging information, so that the reliability of the control can be improved.

### Modification Example

Next, a vehicle exit assist apparatus (hereinafter, also referred to as a “second modification apparatus”) according to a modification example of the second embodiment will be described. The second modification apparatus is different from the second embodiment apparatus in that the second modification apparatus does not include the camera sensor 114 and determination is made whether or not the occupant has intention to exit based on the signal acquired from the door open/close sensor 13.

Specifically, when all conditions 1 to 3 are satisfied, the ECU 110 of the second modification apparatus determines whether or not the occupant has intention to exit from the door on the side where the rear approaching target is detected, based on the signal acquired from the door open/close sensor 13. In the present modification example, the ECU 110 determines that the occupant has intention to exit from the door when the door is in the open state, and determines that the occupant has no intention to exit from the door when the door is in the closed state.

The ECU 110 executes the normal alarm control as the alarm control when determination is made that the occupant has intention to exit from the door on the side where the rear approaching target is detected. On the other hand, the ECU 110 does not execute the alarm control when determination is made that the occupant has no intention to exit from the door on the side where the rear approaching target is detected.

As described above, the second modification apparatus determines whether or not the occupant has intention to exit based on the open/closed state of the door. When determination is made that the door is in the closed state, it is considered that the occupant has not exited because the door has not been opened at least at this time. Therefore, the alarm control is executed solely when determination is made that the occupant has intention to exit based on the open/closed state of the door, so that the reliability of the control can be improved.

Although the vehicle exit assist apparatus according to the present embodiment has been described above, the applicable embodiment is not limited to the above embodiment, and various modifications can be made without departing from the object of the present disclosure.

For example, in the above embodiments and modification examples, the alarm control is executed as the vehicle exit assist control, but the applicable embodiment is not limited to this, and for example, door opening restriction control that restricts the degree of door opening or door lock control that locks the door may be executed as the vehicle exit assist control. Alternatively, the door opening restriction control or the door lock control may be executed in addition to the alarm control. In this case, for example, the normal alarm control and the door opening restriction control (or the door lock control) may be executed as the normal vehicle exit assist control, and the low-level alarm control may be executed as the low-level vehicle exit assist control.

What is claimed is:

1. A vehicle exit assist apparatus comprising:
a target information acquisition device configured to detect a target present around a vehicle and acquire information regarding the detected target as target information; and
a control unit configured to determine whether or not an obstruction target having a possibility of obstructing a safe vehicle exit of an occupant of the vehicle while the vehicle is stopped is present based on the target information, and to execute vehicle exit assist control that assists in the safe vehicle exit of the occupant when determination is made that the obstruction target is present,
wherein the control unit is configured
to determine whether or not the obstruction target is a human being, and
not to execute the vehicle exit assist control when determination is made that the obstruction target is a human being.

2. The vehicle exit assist apparatus according to claim 1, wherein:
the vehicle exit assist control includes a normal vehicle exit assist control and a low-level vehicle exit assist control of which a level of assist is lower than a level of assist of the normal vehicle exit assist control; and
the control unit is configured
to determine whether or not each of a plurality of doors provided in the vehicle is in an open state, when determination is made that the obstruction target is not a human being,
to execute the normal vehicle exit assist control when determination is made that the door on a side where the obstruction target is determined to be present is in an open state, and
to execute the low-level vehicle exit assist control when determination is made that the door on the side where the obstruction target is determined to be present is in a closed state.

3. The vehicle exit assist apparatus according to claim 1, further comprising an imaging device configured to image the occupant in the vehicle and acquire information regarding the imaged occupant as imaging information,
wherein the control unit is configured
to determine whether or not the occupant has intention to exit based on the imaging information, when determination is made that the obstruction target is not a human being,
to execute the vehicle exit assist control when determination is made that the occupant has intention to exit from a door on a side where the obstruction target is determined to be present, and
not to execute the vehicle exit assist control when determination is made that the occupant has no intention to exit from the door on the side where the obstruction target is determined to be present.

4. The vehicle exit assist apparatus according to claim 1, wherein the control unit is configured
to determine whether or not each of a plurality of doors provided in the vehicle is in an open state, when determination is made that the obstruction target is not a human being,
to execute the vehicle exit assist control when determination is made that the door on a side where the obstruction target is determined to be present is in an open state, and
not to execute the vehicle exit assist control when determination is made that the door on the side where the obstruction target is determined to be present is in a closed state.
